(19) United States
(12) Patent Application Publication
(10) Pub. No.: US 2023/0395845 A1
(43) Pub. Date: Dec. 7, 2023

(54) SO2-BASED ELECTROLYTE FOR A RECHARGEABLE BATTERY CELL AND A RECHARGEABLE BATTERY CELL

(71) Applicant: Innolith Technology AG, Basel (CH)

(72) Inventors: Laurent Zinck, Mothern (FR); Christian Pszolla, Bad Schönborn (DE); Rebecca Busch, Bruchsal (DE)

(21) Appl. No.: 18/330,904

(22) Filed: Jun. 7, 2023

Related U.S. Application Data
(63) Continuation of application No. PCT/EP2021/079062, filed on Oct. 20, 2021.

(30) Foreign Application Priority Data
Dec. 9, 2020 (EP) 20 212 727.0

(51) Int. Cl. H01M 10/0562; H01M 4/525; H01M 4/505; H01M 4/62; H01M 4/583; H01M 10/0525

(52) U.S. Cl. CPC H01M 10/0562; H01M 4/525; H01M 4/505; H01M 4/623; H01M 4/583; H01M 10/0525; H01M 2300/008; H01M 2004/028

(57) ABSTRACT

This disclosure relates to an SO₂-based electrolyte for a rechargeable battery cell comprising at least a first conducting salt of the formula (I)

MₐBₘXₙ formula (I)

wherein M is a metal selected from the group formed by alkali metals, alkaline earth metals, metals of group 12 of the periodic table of the elements, and aluminum. B is the element boron. X is a halogen, and a, m, and n are integers. Furthermore, this disclosure relates to a rechargeable battery cell containing an SO₂-based electrolyte comprising at least a first conducting salt of formula (I), an active metal, at least one positive electrode, at least one negative electrode, and a housing.

### RELATED APPLICATIONS

This application is a continuation of PCT/EP2021/079062, filed Oct. 20, 2021, which claims priority to EP 20 212 727.0, filed Dec. 9, 2020, the entire disclosures of both of which are hereby incorporated herein by reference.

### BACKGROUND

This disclosure relates to an SO₂-based electrolyte for a rechargeable battery cell and a rechargeable battery cell.

Rechargeable battery cells are of great importance in many technical fields. In many cases, they are used for applications in which only small rechargeable battery cells with relatively low current ratings are required, such as in the operation of cell phones. In addition, however, there is also a great need for larger rechargeable battery cells for high-energy applications, where mass storage of energy in the form of battery cells is of particular importance for the electric drive of vehicles.

An important requirement for such rechargeable battery cells is high energy density. This means that the rechargeable battery cell should contain as much electrical energy as possible per unit of weight and volume. Lithium has proved particularly advantageous as the active metal for this purpose. The active metal of a rechargeable battery cell is the metal whose ions migrate within the electrolyte to the negative or positive electrode during charging or discharging of the cell and participate in electrochemical processes there. These electrochemical processes lead directly or indirectly to the release of electrons into the external circuit or to the acceptance of electrons from the external circuit. Rechargeable battery cells that contain lithium as the active metal are also known as lithium-ion cells. The energy density of these lithium-ion cells can be increased either by increasing the specific capacity of the electrodes or by increasing the cell voltage.

Both the positive and negative electrodes of lithium-ion cells are designed as insertion electrodes. The term “insertion electrode” as used in this disclosure refers to electrodes that have a crystal structure into which ions of the active material can be inserted and removed during operation of the lithium-ion cell. This means that the electrode processes can take place not only on the surface of the electrodes, but also within the crystal structure. When the lithium-ion cell is charged, the ions of the active metal are removed from the positive electrode and inserted into the negative electrode. When discharging the lithium-ion cell, the reverse process takes place.

The electrolyte is an important functional element of every rechargeable battery cell. It usually contains a solvent or solvent mixture and at least one conducting salt. Solid electrolytes or ionic liquids, for example, contain no solvent but only a conducting salt. The electrolyte is in contact with the positive and negative electrodes of the battery cell. At least one ion of the conducting salt (anion or cation) is mobile in the electrolyte in such a way that, by ionic conduction, a charge transport necessary for the function of the rechargeable battery cell can take place between the electrodes. The electrolyte undergoes oxidative electrochemical decomposition above a certain upper cell voltage of the rechargeable battery cell. This process often leads to irreversible destruction of components of the electrolyte and thus to failure of the rechargeable battery cell. Reductive processes can also decompose the electrolyte above a certain lower cell voltage. To avoid these processes, the positive and negative electrodes are selected so that the cell voltage is below or above the decomposition voltage of the electrolyte. The electrolyte thus determines the voltage window within which a rechargeable battery cell can be operated reversibly.

The lithium-ion cells known from the prior art contain an electrolyte consisting of a conducting salt dissolved in an organic solvent or solvent mixture. The conducting salt is a lithium salt such as lithium hexafluorophosphate (LiPF₆). The solvent mixture may contain, for example, ethylene carbonate. Because of the organic solvent or solvent mixture, such lithium-ion cells are also called organic lithium-ion cells. The negative electrode of these organic lithium-ion cells consists of a carbon coating applied to a copper conducting element. The conducting element provides the necessary electronically conductive connection between the carbon coating and the external circuit. The positive electrode consists of lithium cobalt oxide (LiCoO₂), which is applied to an aluminum conducting element. Both electrodes have a thickness of generally less than 100 μm and are therefore very thin.

It has long been known that the unintentional overcharging of organic lithium-ion cells leads to irreversible decomposition of electrolyte components. In this process, the oxidative decomposition of the organic solvent and/or the conducting salt takes place on the surface of the positive electrode. The heat of reaction generated during this decomposition and the resulting gaseous products are responsible for the subsequent so-called “thermal runaway” and the resulting destruction of the organic lithium-ion cell. The vast majority of charging protocols for these organic lithium-ion cells use the cell voltage as an indicator for the end of charge. Here, accidents due to thermal runaway are particularly likely when using multi-cell battery packs in which several organic lithium-ion cells with mismatching capacities are connected in series.

Therefore, organic lithium-ion cells are problematic with regard to their stability as well as long-term operational safety. Safety risks are also caused in particular by the flammability of the organic solvent or solvent mixture. If an organic lithium-ion cell catches fire or even explodes, the organic solvent of the electrolyte forms a flammable material. To avoid such safety risks, additional measures must be taken. These measures include, in particular, very precise control of the charging and discharging processes of the organic lithium-ion cell and optimized battery design. Furthermore, the organic lithium-ion cell contains components that can melt in the event of an unwanted increase in temperature, thereby flooding the organic lithium-ion cell with molten plastic. This prevents a further uncontrolled temperature increase. However, these measures lead to increased production costs in the manufacture of the organic lithium-ion cell as well as to increased volume and weight. Furthermore, these measures reduce the energy density of the organic lithium-ion cell.

Another disadvantage of organic lithium-ion cells is that any hydrolysis products formed in the presence of residual water are very aggressive towards the cell components of the rechargeable battery cell. For example, the LiPF₆ conducting salt often used in organic cells produces very reactive, aggressive hydrogen fluoride (HF) by reacting with traces of water. Because of this, care must be taken to minimize the residual water content in the electrolyte and cell components when manufacturing such rechargeable battery cells with an organic electrolyte. Production therefore often takes place in cost-intensive drying rooms with extremely low humidity. The problems described above with regard to stability and long-term operational reliability are particularly serious in the development of organic lithium-ion cells, which have, on the one hand, very good electrical energy and performance data and, on the other hand, very high operational reliability and service life, in particular, a high number of usable charge and discharge cycles.

A further development known from the prior art therefore provides for the use of a sulfur dioxide (SO₂)-based electrolyte instead of an organic electrolyte for rechargeable battery cells. Rechargeable battery cells containing an SO₂-based electrolyte exhibit, among other things, high ionic conductivity. The term “SO₂-based electrolyte” is to be understood as an electrolyte which contains SO₂ not only as an additive in low concentration, but in which the mobility of the ions of the conducting salt, which is contained in the electrolyte and causes charge transport, is ensured at least partially, largely, or even completely by SO₂. The SO₂ thus serves as a solvent for the conducting salt. The conducting salt can form a liquid solvate complex with the gaseous SO₂, whereby the SO₂ is bound and the vapor pressure is noticeably lowered compared to pure SO₂. Electrolytes with low vapor pressure are formed. Such SO₂-based electrolytes have the advantage of non-flammability compared to the organic electrolytes described above. This eliminates the safety risks associated with the flammability of the electrolyte.

For example, EP 1 201 004 B1 (hereinafter referred to as [V1]) discloses an SO₂-based electrolyte with the composition LiAlCl₄*SO₂ in combination with a positive electrode of LiCoO₂. To avoid disruptive decomposition reactions during overcharging of the rechargeable battery cell from a potential of 4.1 to 4.2 volts, such as the undesirable formation of chlorine (Cl₂) from lithium tetrachloroaluminate (LiAlCl₄), EP 1 201 004 B1 proposes the use of an additional salt.

EP 2534719 B1 (hereinafter referred to as [V2]) also discloses an SO₂-based electrolyte with, among other things, LiAlCl₄ as the conducting salt. This LiAlCl₄ forms with the SO₂, for example, complexes of the formula LiAlCl₄*1.5 mol SO₂ or LiAlCl₄*6 mol SO₂. Lithium iron phosphate (LiFePO₄) is used as the positive electrode. LiFePO₄ has a lower charging potential (3.7 V) compared to LiCoO₂ (4.2 V). The problem of undesirable overcharge reactions does not occur in this rechargeable battery cell, since potentials of 4.1 volts, which are harmful to the electrolyte, are not reached.

### SUMMARY

In order to further improve the possible applications and properties of SO₂-based electrolytes and rechargeable battery cells containing this electrolyte, this disclosure is based, on the one hand, on the task of providing an SO₂-based electrolyte which, compared with electrolytes known from the prior art,
has a broad electrochemical window so that no oxidative electrolyte decomposition occurs at the positive electrode;
builds up a stable covering layer on the negative electrode, whereby the covering layer capacity should be low, and no further reductive electrolyte decomposition occurs at the negative electrode during further operation;
offers the possibility of operating rechargeable battery cells with high-voltage cathodes due to a wide electrochemical window;
has good solubility for conducting salts and is thus a good ion conductor and electronic insulator, so that ion transport can be facilitated and self-discharge is kept to a minimum;
is also inert to other components of the rechargeable battery cell, such as separators, electrode materials, and cell packaging materials; and
is robust against electrical, mechanical, or thermal abuse.

Such electrolytes are intended to be applicable in particular in rechargeable battery cells, which at the same time have very good electrical energy and performance characteristics, high operational reliability and service life, in particular a high number of usable charging and discharging cycles, all without the electrolyte thereby decomposing during operation of the rechargeable battery cell.

On the other hand, it is the object of this disclosure to specify a rechargeable battery cell which contains an SO₂-based electrolyte and, compared with the rechargeable battery cells known from the prior art, exhibits
improved electrical performance, in particular a high energy density,
an improved overcharge capability and deep discharge capability,
lower self-discharge,
an increased service life, in particular a high number of usable charge and discharge cycles.

This task is solved by an SO₂-based electrolyte having the features of claim 1 and by a rechargeable battery cell having the features of claim 9. Advantageous embodiments of the electrolyte according to this disclosure are defined in claims 2 to 8. Claims 10 to 19 describe advantageous further embodiments of the rechargeable battery cell according to this disclosure.

An SO₂-based electrolyte for a rechargeable battery cell according to this disclosure comprises at least a first conducting salt, which has the formula (I)

MₐBₘXₙ formula (I)

In formula (I), M is a metal selected from the group formed by alkali metals, alkaline earth metals, metals of group 12 of the periodic table of the elements, and aluminum. B represents the element boron of the periodic table of the elements. X stands for a halogen, i.e., an element of the seventh main group or the 17th group of the periodic table of the elements. A, m, and n are integers independent of each other.

The SO₂-based electrolyte according to this disclosure contains SO₂ not only as an additive in low concentration, but in concentrations at which the mobility of the ions of the first conducting salt, which is contained in the electrolyte and causes the charge transport, is at least partially, largely, or even completely ensured by the SO₂. The first conducting salt is dissolved in the electrolyte and shows very good solubility therein. It can form a liquid solvate complex with the gaseous SO₂, in which the SO₂ is bound. In this case, the vapor pressure of the liquid solvate complex drops significantly compared with pure SO₂, and electrolytes with a low vapor pressure are formed. However, it is also within the scope of this disclosure that, depending on the chemical structure of the first conducting salt according to formula (I), no vapor pressure drop may occur during the preparation of the electrolyte according to this disclosure. In the latter case, it is preferred that the preparation of the electrolyte according to this disclosure is carried out at cryogenic temperature or under pressure, preferably using liquid SO₂. The electrolyte may also contain several conducting salts of formula (I), which differ from each other in their chemical structure.

Another aspect of this disclosure provides for a rechargeable battery cell. This rechargeable battery cell comprises the electrolyte according to this disclosure described above or an electrolyte according to one of the advantageous embodiments of the electrolyte according to this disclosure described below. Further, the rechargeable battery cell according to this disclosure comprises an active metal, at least one positive electrode, at least one negative electrode, and a housing.

An electrolyte according to this disclosure and a rechargeable battery cell according to this disclosure containing such an electrolyte have the advantage over electrolytes and rechargeable battery cells known in the prior art that the first conducting salt contained in the electrolyte has a higher oxidation stability and, as a result, shows essentially no or only very little decomposition at higher cell voltages. This leads to increased long-term stability of the electrolyte as well as the rechargeable battery cell.

### Electrolyte

Advantageous embodiments of the electrolyte according to this disclosure are described below.

A first advantageous embodiment of the SO₂-based electrolyte provides that M is lithium (Li). Such lithium compounds of formula (I) have the composition LiₐBₘXₙ, wherein A, m, and n are independent integers, as previously described. In another advantageous further embodiment, X is selected from the group formed by fluorine (F), chlorine (Cl), bromine (Br), and iodine (I). Preferably, X is fluorine or chlorine. A further advantageous embodiment of the SO₂-based electrolyte provides that M is lithium and X is chlorine. Such compounds have the composition LiₐBₘClₙ, wherein a, m, and n are independent integers, as previously described. Examples of compounds of this composition are Li₂B₁₀Cl₁₀ or Li₂B₁₂Cl₁₂. Furthermore, in the previously mentioned formula (I), M can be lithium and X can be fluorine. Such compounds have the composition LiₐBₘFₙ, wherein a, m, and n are independent integers, as previously described. Examples of compounds of this composition are Li₂B₁₀F₁₀ or Li₂B₁₂F₁₂.

A further advantageous embodiment of the rechargeable battery cell according to this disclosure provides that the electrolyte contains at least 1 mol of SO₂, preferably at least 10 mol of SO₂, further preferably at least 30 mol of SO₂, and particularly preferably at least 50 mol of SO₂ per mol of conducting salt. The electrolyte may also contain very high molar proportions of SO₂, the preferred upper limit being 2600 moles of SO₂ per mole of conducting salt, and upper limits of 1500, 1000, 500, and 100 moles of SO₂ per mole of conducting salt being further preferred in that order. In this context, the term “per mole of conducting salt” refers to all conducting salts contained in the electrolyte. SO₂-based electrolytes with such a concentration ratio between SO₂ and the conducting salt have the advantage that they can dissolve a larger amount of conducting salt compared to electrolytes known from the prior art, which are based on an organic solvent mixture, for example. The concentration of SO₂ in the electrolyte affects its conductivity. Thus, by selecting the SO₂ concentration, the conductivity of the electrolyte can be adapted to the intended use of a rechargeable battery cell operated with this electrolyte.

The total content of SO₂ and the first conducting salt may be greater than 50% by weight (percent by weight) of the weight of the electrolyte, preferably greater than 60% by weight, more preferably greater than 70% by weight, more preferably greater than 80% by weight, more preferably greater than 85% by weight, more preferably greater than 90% by weight, more preferably greater than 95% by weight, or more preferably greater than 99% by weight.

The electrolyte may contain at least 5% by weight of SO₂ based on the total amount of electrolyte contained in the rechargeable battery cell, with values of 20% by weight of SO₂, 40% SO₂, and 60% by weight of SO₂ being further preferred. The electrolyte may also contain up to 95% by weight of SO₂, with maximum values of 80% by weight of SO₂ and 90% by weight of SO₂ being preferred in that order.

In order to adapt the conductivity and/or other properties of the electrolyte to a desired value, in another advantageous further embodiment, the electrolyte comprises at least a second conducting salt different from the first conducting salt according to formula (I). This means that, in addition to the first conducting salt, the electrolyte can contain one or also further second conducting salts which differ from the first conducting salt in their chemical composition as well as their chemical structure. The second conducting salt is preferably an alkali metal compound, in particular a lithium compound. The alkali metal compound or the lithium compound are selected from the group formed by an aluminate, a halide, an oxalate, a borate, a phosphate, an arsenate, and a gallate. Further preferably, the second conducting salt is a lithium tetrahaloaluminate, in particular LiAlCl₄.

The electrolyte may have the following composition based on the total weight of the electrolyte composition:
(i) 5 to 99.4% by weight of sulfur dioxide,
(ii) 0.6 to 95% by weight of the first conducting salt, and
(iii) 0 to 25% by weight of the second conducting salt.

As previously mentioned, the electrolyte may contain not only a first conducting salt according to formula (I) and a second conducting salt, but also a plurality of first conducting salts according to formula (I) and a plurality of second conducting salts, respectively. In the latter case, the aforementioned percentages also include a plurality of first conducting salts and a plurality of second conducting salts.

Preferably, the electrolyte has only a small percentage or even no percentage of at least one organic solvent. The percentage of organic solvents in the electrolyte, which is present, for example, in the form of a solvent or a mixture of several organic solvents, may be at most 50% by weight of the weight of the electrolyte. Preferred are lower proportions of at most 40% by weight, more preferably at most 30% by weight, more preferably at most 20% by weight, more preferably at most 15% by weight, more preferably at most 10% by weight, more preferably at most 5% by weight or more preferably at most 1% by weight of the weight of the electrolyte. Particularly preferably, the electrolyte is substantially free of organic solvents. Due to the only small proportion of organic solvents or even their complete absence, the electrolyte is either hardly combustible or not combustible at all. This increases the operational safety of a rechargeable battery cell operated with such an SO₂-based electrolyte. Based on the total weight of the electrolyte composition, in another advantageous further embodiment, the electrolyte has the following composition:
(i) 5 to 99.4% by weight of sulfur dioxide,
(ii) 0.6 to 95% by weight of the first conducting salt,
(iii) 0 to 25% by weight of the second conducting salt, and
(iv) 0 to 50% by weight of organic solvent.

### Active Metal

Advantageous further embodiments of the rechargeable battery cell according to this disclosure with respect to the active metal are described below:

In a first advantageous further embodiment of the rechargeable battery cell, the active metal is
an alkali metal, in particular lithium or sodium;
an alkaline earth metal, in particular calcium;
a metal of group 12 of the periodic table, in particular zinc; or
aluminum.

### Negative Electrode

Advantageous further embodiments of the rechargeable battery cell according to this disclosure with respect to the negative electrode are described below:

Another advantageous further embodiment of the rechargeable battery cell provides that the negative electrode is an insertion electrode. This insertion electrode contains an insertion material as active material, into which the ions of the active metal can be stored during charging of the rechargeable battery cell and from which the ions of the active metal can be removed during discharging of the rechargeable battery cell. This means that electrode processes can occur not only on the surface of the negative electrode, but also inside the negative electrode. For example, if a lithium-based conducting salt is used, lithium ions can be stored in the insertion material during charging of the rechargeable battery cell and can be removed from it during discharging of the rechargeable battery cell. Preferably, the negative electrode contains carbon as the active material or insertion material, in particular in the modification graphite. However, it is also within the scope of this disclosure for the carbon to be in the form of natural graphite (flake-feed or rounded), synthetic graphite (mesophase graphite), graphitized MesoCarbon MicroBeads (MCMB), carbon coated graphite, or amorphous carbon.

In another advantageous further embodiment of the rechargeable battery cell according to this disclosure, the negative electrode comprises lithium intercalation anode active materials that do not contain carbon, such as lithium titanates (e.g., Li₄Ti₅O₁₂).

Another advantageous further development of the rechargeable battery cell according to this disclosure provides that the negative electrode comprises lithium alloy-forming anode active materials. These are, for example, lithium storing metals and metal alloys (e.g., Si, Ge, Sn, SnCoₓC_{y}, SnSiₓ, and the like) and oxides of the lithium storing metals and metal alloys (e.g., SnOₓ, SiOₓ, oxide glasses of Sn, Si, and the like).

In another advantageous further embodiment of the rechargeable battery cell according to this disclosure, the negative electrode includes conversion anode active materials. These conversion anode active materials may be, for example, transition metal oxides in the form of manganese oxides (MnOₓ), iron oxides (FeOₓ), cobalt oxides (CoOₓ), nickel oxides (NiOₓ), copper oxides (CuOₓ), or metal hydrides in the form of magnesium hydride (MgH₂), titanium hydride (TiH₂), aluminum hydride (AlH₃), and boron, aluminum, and magnesium-based ternary hydrides and the like.

In another advantageous further embodiment of the rechargeable battery cell according to this disclosure, the negative electrode comprises a metal, in particular metallic lithium.

Another advantageous further embodiment of the rechargeable battery cell according to this disclosure provides that the negative electrode is porous, wherein the porosity is preferably at most 50%, further preferably at most 45%, further preferably at most 40%, further preferably at most 35%, further preferably at most 30%, further preferably at most 20%, and particularly preferably at most 10%. The porosity represents the void volume to total volume of the negative electrode, where the void volume is formed by so-called pores or voids. This porosity leads to an increase of the inner surface of the negative electrode. Furthermore, the porosity reduces the density of the negative electrode and thus its weight. The individual pores of the negative electrode can preferably be completely filled with the electrolyte during operation.

Another advantageous further development of the battery cell according to this disclosure provides that the negative electrode has a conducting element. This means that, in addition to the active material or insertion material, the negative electrode also comprises a conducting element. This conducting element serves to enable the required electronically conductive connection of the active material of the negative electrode. For this purpose, the conducting element is in contact with the active material involved in the electrode reaction of the negative electrode. This conducting element can be planar in the form of a thin metal sheet or a thin metal foil. The thin metal foil preferably has an openwork or mesh-like structure. The active material of the negative electrode is preferably applied to the surface of the thin metal sheet or foil. Such planar conducting elements have a thickness in the range of 5 μm to 50 μm. A thickness of the planar conducting element in the range of 10 μm to 30 μm is preferred. When using planar conducting elements, the negative electrode can have a total thickness of at least 20 μm, preferably at least 40 μm and particularly preferably at least 60 μm. The maximum thickness is at most 200 μm, preferably at most 150 μm, and particularly preferably at most 100 μm. The area-specific capacity of the negative electrode preferably has at least 0.5 mAh/cm² when a planar conducting element is used, with the following values being further preferred in this order: 1 mAh/cm², 3 mAh/cm², 5 mAh/cm², 10 mAh/cm².

Furthermore, there is also the possibility that the conducting element can be formed three-dimensionally in the form of a porous metal structure, in particular in the form of a metal foam. In this context, the term “three-dimensional porous metal structure” refers to any structure consisting of metal that extends not only over the length and width of the planar electrode like the thin metal sheet or metal foil, but also over its thickness dimension. The three-dimensional porous metal structure is so porous that the active material of the negative electrode can be incorporated into the pores of the metal structure. The amount of incorporated or applied active material is the charging of the negative electrode. If the conducting element is formed three-dimensionally in the form of a porous metal structure, in particular in the form of a metal foam, then the negative electrode preferably has a thickness of at least 0.2 mm, preferably at least 0.3 mm, more preferably at least 0.4 mm, further preferably at least 0.5 mm and particularly preferably at least 0.6 mm. The thickness of the electrodes in this case is significantly greater compared to negative electrodes, which are used in organic lithium-ion cells. A further advantageous embodiment provides that the area-specific capacity of the negative electrode is preferably at least 2.5 mAh/cm² when a three-dimensional conducting element in the form of a metal foam is used, in particular in the form of a metal foam, the following values being further preferred in this order: 5 mAh/cm², 10 mAh/cm², 15 mAh/cm², 20 mAh/cm², 25 mAh/cm², 30 mAh/cm². If the conducting element is formed three-dimensionally in the form of a porous metal structure, in particular in the form of a metal foam, the amount of active material of the negative electrode, i.e., the charging of the electrode, relative to its area, is at least 10 mg/cm², preferably at least 20 mg/cm², more preferably at least 40 mg/cm², more preferably at least 60 mg/cm², more preferably at least 80 mg/cm² and particularly preferably at least 100 mg/cm². This charging of the negative electrode has a positive effect on the charging process as well as the discharging process of the rechargeable battery cell.

In another advantageous further embodiment of the battery cell according to this disclosure, the negative electrode comprises at least one binder. This binder is preferably a fluorinated binder, in particular a polyvinylidene fluoride and/or a terpolymer formed from tetrafluoroethylene, hexafluoropropylene, and vinylidene fluoride. However, it can also be a binder consisting of a polymer built up from monomeric structural units of a conjugated carboxylic acid or from the alkali metal, alkaline earth metal, or ammonium salt of this conjugated carboxylic acid or from a combination thereof. Furthermore, the binder may also comprise a polymer based on monomeric styrene and butadiene structural units. Furthermore, the binder can also be a binder from the group of carboxymethyl celluloses. The binder is preferably present in the negative electrode in a concentration of at most 20% by weight, further preferably at most 15% by weight, further preferably at most 10% by weight, further preferably at most 7% by weight, further preferably at most 5% by weight, and particularly preferably at most 2% by weight based on the total weight of the negative electrode.

### Positive Electrode

Advantageous further embodiments of the rechargeable battery cell according to this disclosure with respect to the positive electrode are described below:

A first advantageous further embodiment of the rechargeable battery cell according to this disclosure provides that the positive electrode is chargeable at least up to an upper potential of 4.0 volts, preferably up to a potential of 4.4 volts, more preferably of at least a potential of 4.8 volts, more preferably at least up to a potential of 5.2 volts, more preferably at least up to a potential of 5.6 volts, and particularly preferably at least up to a potential of 6.0 volts.

In another advantageous further embodiment of the rechargeable battery cell according to this disclosure, the positive electrode comprises at least one active material. This can store ions of the active metal and release and reabsorb the ions of the active metal during operation of the battery cell.

In another advantageous further embodiment of the rechargeable battery cell according to this disclosure, the positive electrode comprises at least one intercalation compound. For the purposes of this disclosure, the term “intercalation compound” is to be understood as a subcategory of the insertion materials previously described. This intercalation compound acts as a host matrix which has vacancies that are interconnected. The ions of the active metal can diffuse into these vacancies during the discharge process of the rechargeable battery cell and be intercalated there. In the course of this intercalation of the ions of the active metal, only minor or no structural changes occur in the host matrix.

In another further advantageous embodiment of the rechargeable battery cell according to this disclosure, the positive electrode contains at least one conversion compound as active material. For the purposes of this disclosure, the term “conversion compounds” means materials that form other materials during electrochemical activity; i.e., chemical bonds are broken and reestablished during charging and discharging of the battery cell. During the absorption or release of the ions of the active metal, structural changes occur in the matrix of the conversion compound.

In another advantageous further embodiment of the rechargeable battery cell according to this disclosure, the active material has the composition AₓM′_{y}M″_{z}Oₐ. In this composition AₓM′_{y}M″_{z}Oₐ:
A is at least one metal selected from the group formed by the alkali metals, the alkaline earth metals, the metals of group 12 of the periodic table, or aluminum,
M′ is at least one metal selected from the group formed by the elements Ti, V, Cr, Mn, Fe, Co, Ni, Cu, and Zn;
M″ is at least one element selected from the group formed by the elements of groups 2, 3, 4, 5, 6, 7, 8, 9, 10, 11, 12, 13, 14, 15, and 16 of the periodic table of the elements;
x and y are independently numbers greater than 0;
z is a number greater than or equal to 0; and
a is a number greater than 0.

A is preferably the metal lithium, i.e., the compound may have the composition LiₓM′_{y}M″_{z}Oₐ.

The indices y and z in the composition AₓM′_{y}M″_{z}Oₐ refer to the totality of metals and elements represented by M′ and M″, respectively. For example, if M′ comprises two metals M′ 1 and M′2, the following applies to the index y: y=y1+y2, where y1 and y2 represent the indices of the metals and M′2. The indices x, y, z, and a must be selected so that there is charge neutrality within the composition. Examples of compounds in which M′ comprises two metals are lithium nickel manganese cobalt oxides of the composition LiₓNi_{y1}Mn_{y2}Co_{z}O₂ with M′¹=Ni, M′²=Mn, and M″=Co. Examples of compounds in which z=0, i.e., those which have no further metal or element M″, are lithium cobalt oxides LiₓCo_{y}Oₐ. For example, if M″ comprises two elements, one being a metal M″¹ and the other phosphorus as M″², the index z is: z=z1+z2, where z1 and z2 are the indices of the metal M″¹ and the phosphorus (M″²). The indices x, y, z, and a must be selected so that there is charge neutrality within the composition. Examples of compounds in which A comprises lithium, M″, a metal M″1, and phosphorus as M″² are lithium iron manganese phosphates LiₓFe_{y}Mn_{z1}P_{z2}O₄ with A=Li, M′=Fe, M″¹=Mn, and M″²=P and z2=1. In another composition, M″ may comprise two nonmetals, for example fluorine as M″1 and sulfur as M″2. Examples of such compounds are lithium iron fluorosulfates LiₓFe_{y}F_{z1}S_{z2}O₄ with A=Li, M′=Fe, M″¹=Mn, and M″²=P.

Another advantageous further embodiment of the rechargeable battery cell according to this disclosure provides that M′ consists of the metals nickel and manganese, and M″ is cobalt. These may be compositions of the formula LiₓNi_{y1}Mn_{y2}Co_{z}O₂ (NMC), i.e., lithium nickel manganese cobalt oxides having the structure of layered oxides. Examples of these lithium nickel manganese cobalt oxide active materials include LiNi_{1/3}Mn_{1/3}Co_{1/3}O₂ (NMC111), LiNi_{0.6}Mn_{0.2}Co_{0.2}O₂ (NMC622), and LiNi_{0.8}Mn_{0.1}Co_{0.1}O₂ (NMC811). Other compounds of lithium nickel manganese cobalt oxide may have the composition LiNi_{0.5}Mn_{0.3}Co_{0.2}O₂, LiNi_{0.5}Mn_{0.25}Co_{0.25}O₂, LiNi_{0.52}Mn_{0.32}Co_{0.16}O₂, LiNi_{0.55}Mn_{0.30}Co_{0.15}O₂, LiNi_{0.58}Mn_{0.14}Co_{0.28}O₂, LiNi_{0.64}Mn_{0.18}Co_{0.18}O₂, LiNi_{0.65}Mn_{0.27}Co_{0.08}O₂, LiNi_{0.7}Mn_{0.2}Co_{0.1}O₂, LiNi_{0.7}Mn_{0.15}Co_{0.15}O₂, LiNi_{0.72}Mn_{0.10}Co_{0.18}O₂, LiNi_{0.76}Mn_{0.14}Co_{0.10}O₂, LiNi_{0.86}Mn_{0.04}Co_{0.10}O₂, LiNi_{0.90}Mn_{0.05}Co_{0.05}O₂, LiNi_{0.95}Mn_{0.025}Co_{0.025}O₂, or any combination thereof. These compounds can be used to produce positive electrodes for rechargeable battery cells with a cell voltage above 4.6 volts.

Another advantageous further embodiment of the rechargeable battery cell according to this disclosure provides that the active material is a metal oxide rich in lithium and manganese (Lithium- and Manganese-Rich Oxide Material). This metal oxide may have the composition LiₓMn_{y}M“_{z}Oₐ. M′ thus represents the metal manganese (Mn) in the formula LiₓM′_{y}M”_{z}Oₐ described above. Here, the index x is greater than or equal to 1, the index y is greater than the index z or greater than the sum of the indices z1+z2+z3, etc., respectively. If, for example, M″ comprises two metals M″¹ and M″² with indices z1 and z2 (e.g., Li_{1/2}Mn_{0.525}Ni_{0.175}Co_{0.1}O₂ with M″¹=Ni z1=0.175 and M″²=Co z2=0.1) then the following applies to the index y: y>z1+z2. The index z is greater than or equal to 0 and the index a is greater than 0. The indices x, y, z, and a must be selected so that there is charge neutrality within the composition. Metal oxides rich in lithium and manganese can also be described by the formula mLi₂MnO₃·(1−m)LiM′O₂ with 0<m<1. Examples of such compounds are Li_{1.2}Mn_{0.525}Ni_{0.175}Co_{0.1}O₂, Li_{1.2}Mn_{0.6}Ni_{0.2}O₂ or Li_{1.2}Ni_{0.13}Co_{0.13}Mn_{0.54}O₂.

Another advantageous further embodiment of the rechargeable battery cell according to this disclosure provides that the composition has the formula AₓM′_{y}M“_{z}O₄. These compounds are spinel structures. For example, A may be lithium, M′ may be cobalt, and M” may be manganese. In this case, the active material is lithium cobalt manganese oxide (LiCoMnO₄). LiCoMnO₄ can be used to produce positive electrodes for rechargeable battery cells with a cell voltage above 4.6 volts. This LiCoMnO₄ is preferably free of Mn³⁺. In another example, M′ can be nickel, and M″ can be manganese. In this case, the active material is lithium nickel manganese oxide (LiNiMnO₄). The molar proportions of the two metals M′ and M″ may vary. Lithium nickel manganese oxide, for example, can have the composition LiNi_{0.5}Mn_{1.5}O₄.

In another advantageous further embodiment of the rechargeable battery cell according to this disclosure, the positive electrode contains as active material at least one active material which is a conversion compound. Conversion compounds undergo a solid-state redox reaction during the absorption of the active metal, e.g., lithium or sodium, in which the crystal structure of the material changes. This occurs with the breaking and recombination of chemical bonds. Fully reversible reactions of transformation compounds can be, for example, as follows:
Type A: MX_{z}+y Li↔M+z Li_{(y/z)}X
Type B: X+y Li↔Li_{y}X

Examples of conversion are FeF₂, FeF₃, CoF₂, CuF₂, NiF₂, BiF₃, FeCl₃, FeCl₂, CoCl₂, NiCl₂, CuCl₂, AgCl, LiCl, S, Li₂S, Se, Li₂Se, Te, I, and LiI.

In another advantageous further embodiment, the compound has the composition AₓM′_{y}M″_{z1}M″_{z2}O₄, where M″ is phosphorus and z2 has the value 1. The compound having the composition LiₓM′_{y}M″_{z1}M″_{z2}O₄ is so-called lithium metal phosphates. In particular, this compound has the composition LiₓFe_{y}Mn_{z1}P_{z2}O₄. Examples of lithium metal phosphates are lithium iron phosphate (LiFePO₄) or lithium iron manganese phosphates (Li(Fe_{y}Mn_{z})PO₄). An example of a lithium iron manganese phosphate is the phosphate of composition Li(Fe_{0.3}Mn_{0.7})PO₄. An example of a lithium iron manganese phosphate is the phosphate of composition Li(Fe_{0.3}Mn_{0.7})PO₄. Lithium metal phosphates of other compositions can also be used for the battery cell according to this disclosure.

Many of the positive electrode active materials described are high voltage active materials. This means that they can be used to produce electrodes which are chargeable at least up to an upper potential of 4.0 volts, preferably up to an upper potential of 4.4 volts.

Another advantageous further embodiment of the rechargeable battery cell according to this disclosure provides that the positive electrode comprises at least one metal compound. This metal compound is selected from the group formed by a metal oxide, a metal halide, and a metal phosphate. Preferably, the metal of this metal compound is a transition metal of atomic numbers 22 to 28 of the periodic table of the elements, in particular cobalt, nickel, manganese, or iron.

Another advantageous further embodiment of the rechargeable battery cell according to this disclosure provides that the positive electrode comprises at least one metal compound having the chemical structure of a spinel, a layer oxide, a conversion compound, or a polyanionic compound.

It is within the scope of this disclosure that the positive electrode contains as active material at least one of the described compounds or a combination of the compounds. A combination of the compounds means a positive electrode containing at least two of the described materials.

Another advantageous further embodiment of the battery cell according to this disclosure provides that the positive electrode comprises a conducting element. This means that, in addition to the active material, the positive electrode also comprises a conducting element. This conducting element serves to enable the required electronically conductive connection of the active material of the positive electrode. For this purpose, the conducting element is in contact with the active material involved in the electrode reaction of the positive electrode.

This conducting element can be planar in the form of a thin metal sheet or a thin metal foil. The thin metal foil preferably has an openwork or mesh-like structure. The planar conducting element can also be made of a plastic film coated with metal. These metal coatings have a thickness in the range of 0.1 μm to 20 μm. The active material of the positive electrode is preferably deposited on the surface of the thin metal sheet, the thin metal foil, or the metal-coated plastic foil. The active material may be deposited on the front and/or back surface of the planar conducting element. Such planar conducting elements have a thickness in the range of 5 μm to 50 μm. A thickness of the planar conducting element in the range of 10 μm to 30 μm is preferred. When planar conducting elements are used, the positive electrode may have a total thickness of at least 20 μm, preferably at least 40 μm, and particularly preferably at least 60 μm. The maximum thickness is at most 200 μm, preferably at most 150 μm, and particularly preferably at most 100 μm. The area-specific capacity of the positive electrode relative to the coating of one side preferably has at least 0.5 mAh/cm² when a planar conducting element is used, the following values being further preferred in this order: 1 mAh/cm², 3 mAh/cm², 5 mAh/cm², 10 mAh/cm², 15 mAh/cm², 20 mAh/cm².

Furthermore, there is also the possibility that the conducting element of the positive electrode is formed three-dimensionally in the form of a porous metal structure, in particular in the form of a metal foam. The three-dimensional porous metal structure is so porous that the active material of the positive electrode can be incorporated into the pores of the metal structure. The amount of incorporated or applied active material is the loading of the positive electrode. If the conducting element is formed three-dimensionally in the form of a porous metal structure, in particular in the form of a metal foam, then the positive electrode preferably has a thickness of at least 0.2 mm, preferably at least 0.3 mm, more preferably at least 0.4 mm, further preferably at least 0.5 mm, and particularly preferably at least 0.6 mm. A further advantageous embodiment provides that the area-specific capacity of the positive electrode is preferably at least 2.5 mAh/cm² when a three-dimensional conducting element is used, in particular in the form of a metal foam, the following values being further preferred in this order: 5 mAh/cm², 15 mAh/cm², 25 mAh/cm², 35 mAh/cm², 45 mAh/cm², 55 mAh/cm², 65 mAh/cm², 75 mAh/cm². If the conducting element is formed three-dimensionally in the form of a porous metal structure, in particular in the form of a metal foam, the amount of active material of the positive electrode, i.e., the loading of the electrode, relative to its area, is at least 10 mg/cm′, preferably at least 20 mg/cm′, further preferably at least 40 mg/cm′, further preferably at least 60 mg/cm′, further preferably at least 80 mg/cm², and particularly preferably at least 100 mg/cm′. This loading of the positive electrode has a positive effect on the charging process as well as the discharging process of the rechargeable battery cell.

In another advantageous further embodiment of the battery cell according to this disclosure, the positive electrode comprises at least one binder. This binder is preferably a fluorinated binder, in particular a polyvinylidene fluoride and/or a terpolymer formed from tetrafluoroethylene, hexafluoropropylene, and vinylidene fluoride. However, it can also be a binder consisting of a polymer built up from monomeric structural units of a conjugated carboxylic acid or from the alkali metal, alkaline earth metal, or ammonium salt of this conjugated carboxylic acid or from a combination thereof. Furthermore, the binder may also comprise a polymer based on monomeric styrene and butadiene structural units. Furthermore, the binder can also be a binder from the group of carboxymethyl celluloses. The binder is preferably present in the positive electrode in a concentration of at most 20% by weight, further preferably at most 15% by weight, further preferably at most 10% by weight, further preferably at most 7% by weight, further preferably at most 5% by weight, and particularly preferably at most 2% by weight based on the total weight of the positive electrode.

### Structure of the Rechargeable Battery Cell

Advantageous further embodiments of the rechargeable battery cell according to this disclosure are described below with regard to its structure:

In order to further improve the function of the rechargeable battery cell, another advantageous further embodiment of the rechargeable battery cell according to this disclosure provides that the rechargeable battery cell comprises a plurality of negative electrodes and a plurality of positive electrodes which are arranged alternately stacked in the housing. Here, the positive electrodes and the negative electrodes are preferably electrically separated from each other by separators.

The separator may be formed of a nonwoven fabric, a membrane, a woven fabric, a knitted fabric, an organic material, an inorganic material, or a combination thereof. Organic separators can be made of unsubstituted polyolefins (e.g., polypropylene or polyethylene), partially to fully halogen-substituted polyolefins (e.g., partially to fully fluorine-substituted, especially PVDF, ETFE, PTFE), polyesters, polyamides, or polysulfones. Separators containing a combination of organic and inorganic materials include glass fiber textile materials in which the glass fibers are coated with a suitable polymeric coating. The coating preferably contains a fluorine-containing polymer such as polytetrafluoroethylene (PTFE), ethylene tetrafluoroethylene (ETFE), perfluoroethylene propylene (FEP), THV (terpolymer of tetrafluoroethylene, hexafluoroethylene, and vinylidene fluoride), a perfluoroalkoxy polymer (PFA), aminosilane, polypropylene, or polyethylene (PE). The separator may also be present folded in the rechargeable battery cell housing, for example in the form of a so-called “Z-folding.” In this Z-folding, a strip-shaped separator is folded through or around the electrodes in a Z-shaped manner. Furthermore, the separator can also be in the form of separator paper.

It is also within the scope of this disclosure that the separator may be formed as coating, wherein each positive electrode or each negative electrode is enveloped by the coating. The coating may be formed of a nonwoven material, a membrane, a woven fabric, a knitted fabric, an organic material, an inorganic material, or a combination thereof.

Coating the positive electrode results in more uniform ion migration and ion distribution in the rechargeable battery cell. The more uniform the ion distribution, especially in the negative electrode, the higher the possible loading of the negative electrode with active material and consequently the usable capacity of the rechargeable battery cell can be. At the same time, risks that may be associated with uneven loading and resulting deposition of the active metal are avoided. These advantages are particularly effective when the positive electrodes of the rechargeable battery cell are encased in the coating.

Preferably, the areal dimensions of the electrodes and the coating may be matched such that the outer dimensions of the coating of the electrodes and the outer dimensions of the non-clad electrodes match in at least one dimension.

Preferably, the areal extent of the coating may be greater than the areal extent of the electrode. In this case, the coating extends beyond a boundary of the electrode. Two layers of the coating covering the electrode on both sides can therefore be joined together at the edge of the positive electrode by an edge joint.

In a further advantageous embodiment of the rechargeable battery cell according to this disclosure, the negative electrodes have a coating, while the positive electrodes have no coating.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows a cross-sectional view of a first embodiment of a rechargeable battery cell according to this disclosure;

FIG. 2 shows a detailed view of an electron micrograph of the three-dimensional porous structure of the metal foam of the first embodiment of FIG. 1;

FIG. 3 shows a cross-sectional view of a second embodiment of a rechargeable battery cell according to this disclosure;

FIG. 4 shows a detail of the second embodiment of FIG. 3;

FIG. 5 shows an exploded view of a third embodiment of the rechargeable battery cell according to this disclosure without its housing;

FIG. 6 shows the potential in [V] of a test full cell filled with electrolyte 1 and a test full cell filled with reference electrolyte during charging as a function of the capacity, which is related to the theoretical capacity of the negative electrode, during a covering layer formation on the negative electrode;

FIG. 7 shows a potential curve in volts [V] as a function of the percentage charge of a test full cell filled with electrolyte 1 and with nickel manganese cobalt oxide as the active material of the positive electrode, where the final charge voltage is 4.4 volts and the final discharge voltage is 2.5 volts;

FIG. 8 shows the discharge capacity as a function of the cycle number of test full cells containing either electrolyte 1 or the reference electrolyte;

FIG. 9 shows the discharge capacity as a function of the cycle number of test full cells containing either electrolyte 2 or the reference electrolyte;

FIG. 10 shows the conductivity in [mS/cm] of electrolyte 1 as a function of concentration; and

FIG. 11 shows the conductivity in [mS/cm] of electrolyte 2 as a function of concentration.

### DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of this disclosure.

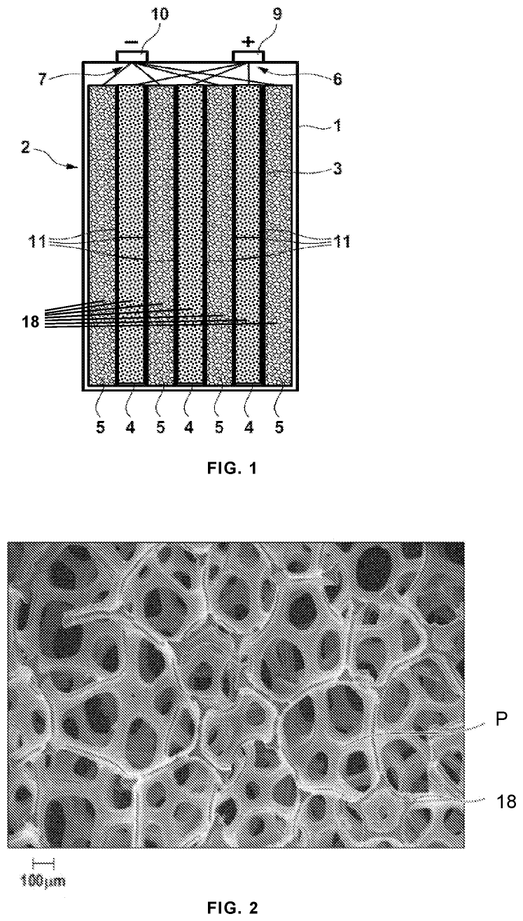

FIG. 1 shows a cross-sectional view of a first embodiment of a rechargeable battery cell 2 according to this disclosure. This rechargeable battery cell 2 is designed as a prismatic cell and has, among other things, a housing 1. This housing 1 encloses an electrode arrangement 3 comprising three positive electrodes 4 and four negative electrodes 5. The positive electrodes 4 and the negative electrodes 5 are alternately stacked in the electrode arrangement 3. However, the housing 1 can also accommodate more positive electrodes 4 and/or negative electrodes 5. Generally, it is preferred if the number of negative electrodes 5 is one greater than the number of positive electrodes 4. As a result, the outer end surfaces of the electrode stack are formed by the electrode surfaces of the negative electrodes 5. The electrodes 4, 5 are connected to corresponding terminal contacts 9, 10 of the rechargeable battery cell 2 via electrode terminals 6, 7. The rechargeable battery cell 2 is filled with an SO₂-based electrolyte in such a way that the electrolyte penetrates as completely as possible into all pores or cavities, in particular within the electrodes 4, 5. The electrolyte is not visible in FIG. 1. In the present embodiment, the positive electrodes 4 contain an intercalation compound as active material. This intercalation compound is LiNi_{0.6}Mn_{0.2}Co_{0.2}O₂.

In the present embodiment, the electrodes 4, 5 are flat, i.e., as layers with a smaller thickness in relation to their surface area. They are each separated from each other by separators 11. The housing 1 of the rechargeable battery cell 2 is substantially cuboidal in shape, with the electrodes 4, 5 and the walls of the housing 1 shown in sectional view extending perpendicularly to the drawing plane and being substantially straight and planar in shape. However, the rechargeable battery cell 2 may also be formed as a wound cell, in which the electrodes are formed as thin layers wound together with a separator material. The separators 11 separate the positive electrode 4 and the negative electrode 5 spatially and electrically on the one hand and are permeable to the ions of the active metal, among other things, on the other hand. In this way, large electrochemically effective surfaces are created which enable a correspondingly high current yield.

The electrodes 4, 5 further comprise a conductive element which serves to enable the required electronically conductive connection of the active material of the respective electrode. This conductive element is in contact with the active material involved in the electrode reaction of the respective electrode 4, 5 (not shown in FIG. 1). The conductive element is designed in the form of a porous metal foam 18. The metal foam 18 extends over the thickness dimension of the electrodes 4, 5. The active material of the positive electrodes 4 and the negative electrodes 5 is respectively incorporated into the pores of this metal foam 18 so that it fills its pores uniformly over the entire thickness of the metal structure. To improve mechanical strength, the positive electrodes 4 contain a binder. This binder is a fluoropolymer. The negative electrodes 5 contain carbon as the active material, which is designed as an insertion material and is used to hold lithium ions, and also a binder. The structure of the negative electrode 5 is similar to that of the positive electrode 4.

FIG. 2 shows an electron micrograph of the three-dimensional porous structure of the metal foam 18 of the first embodiment of FIG. 1. On the basis of the scale indicated, it can be seen that the pores P have an average diameter of more than 100 μm, i.e., are relatively large. This metal foam 18 is a metal foam made of nickel.

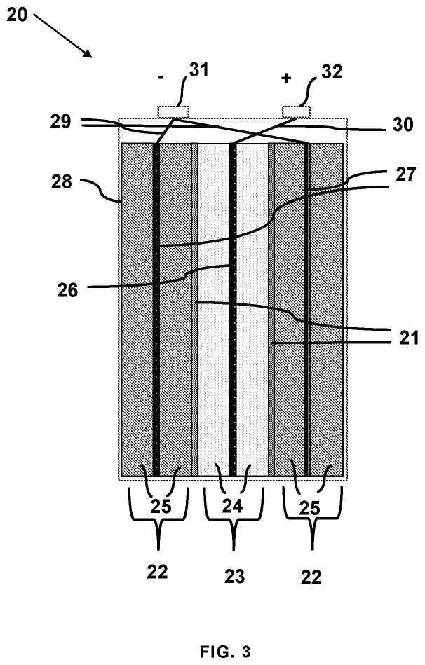

FIG. 3 shows a cross-sectional view of a second embodiment of a rechargeable battery cell 20 according to this disclosure. This second embodiment differs from the first embodiment shown in FIG. 1 in that the electrode arrangement comprises a positive electrode 23 and two negative electrodes 22. They are each separated from each other by separators 21 and surrounded by a housing 28. The positive electrode 23 comprises a conductive element 26 in the form of a planar metal foil to which the active material 24 of the positive electrode 23 is applied on both sides. The negative electrodes 22 also comprise a conductive element 27 in the form of a planar metal foil to which the active material 25 of the negative electrode 22 is applied on both sides. Both electrodes also contain binders. Alternatively, the planar conductive elements of the edge electrodes, i.e., the electrodes which terminate the electrode stack, can be coated with active material on one side only. The non-coated side then faces the wall of the housing 28. The electrodes 22, 23 are connected via electrode terminals 29, 30 to corresponding terminal contacts 31, 32 of the rechargeable battery cell 20.

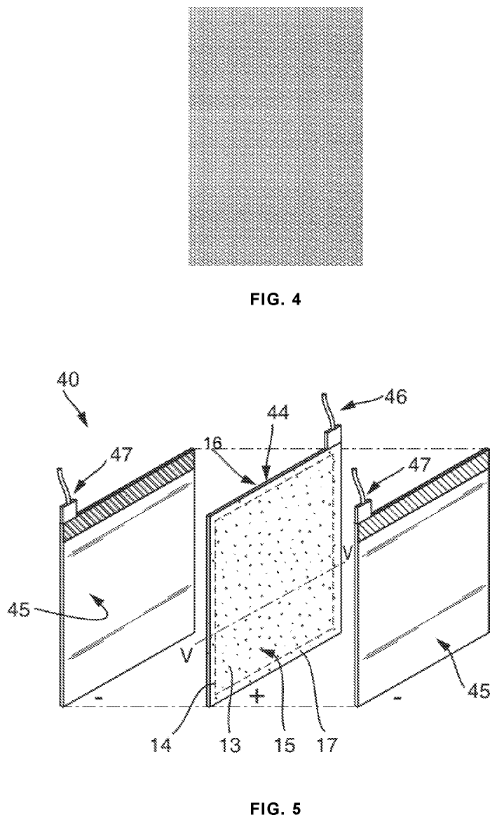

FIG. 4 shows the planar metal foil which serves in each case as a conductive element 26, 27 for the positive electrode 23 and the negative electrodes 22 in the second embodiment of FIG. 3. This metal foil has an openwork or net-like structure with a thickness of 20 μm.

FIG. 5 shows an exploded view of a third embodiment of a rechargeable battery cell 40 according to this disclosure. This third embodiment differs from the two previously explained embodiments in that the positive electrode 44 is encased by a coating 13. In this case, a surface area of the coating 13 is greater than a surface area of the positive electrode 44, the boundary 14 of which is shown as a dashed line in FIG. 5. Two layers 15, 16 of the coating 13 covering the positive electrode 44 on both sides are joined together at the circumferential edge of the positive electrode 44 by an edge joint 17. The two negative electrodes 45 are not enveloped. The electrodes 44 and 45 can be contacted via electrode terminals 46 and 47.

### Example 1: Preparation of a Reference Electrolyte

A reference electrolyte used for the examples described below was prepared according to the method described in patent specification EP 2 954 588 B1. First, lithium chloride (LiCl) was dried under vacuum at 120° C. for three days. Aluminum particles (Al) were dried under vacuum at 450° C. for two days. LiCl, aluminum chloride (AlCl₃), and Al were mixed in a molar ratio AlCl₃:LiCl:Al of 1:1.06:0.35 mixed together in a glass bottle with an opening that allowed gas to escape. Then, this mixture was heat-treated stepwise to produce a molten salt. After cooling, the formed molten salt was filtered, then cooled to room temperature, and finally SO₂ was added until the desired molar ratio of SO₂ to LiAlCl₄ was formed. The reference electrolyte thus formed had the composition LiAlCl₄*x SO₂, where x is dependent on the amount of SO₂ added.

### Example 2: Preparation of Two Embodiments 1 and 2 of the Electrolyte According to this Disclosure

For the experiments described below, two embodiments 1 and 2 of the electrolyte according to this disclosure were prepared (hereinafter referred to as electrolytes 1 and 2).

For this purpose, two different first conducting salts according to formula (I) were first prepared according to a preparation procedure described in the following documents [V3], [V4] and [V5]:
[V3] Geis et al., Dalton Trans. 2009, 2687-2694,
[V4] Dunks et al. Inorg. Synth. 1983, 22, 202, M. F. Hawthorne, R. L. Pilling, Inorg.

Synth. 1967, 9, 16
[V5] J. W. Johnson, J. F. Brody; J. Electrochem. Soc. 1982, 129, 2213-2219

The two first conducting salts thus prepared according to formula (I) had the molecular formulae Li₂B₁₂Cl₁₂ (compound 1) and Li₂B₁₀Cl₁₀ (compound 2).

After the synthesis of the conducting salts, the solution of compounds 1 and 2 in SO₂ was carried out to prepare electrolytes 1 and 2. The preparation of the electrolytes was carried out at cryogenic temperature or under pressure according to the following listed process steps 1 to 4:
1) Presentation of the respective compound 1 or 2 in a respective pressure flask with riser tube,
2) Evacuation of the pressure flasks,
3) Inflow of liquid SO₂, and
4) Repeating steps 2+3 until the target amount of SO₂ has been added.

The respective concentration of compounds 1 and 2 in electrolytes 1 and 2 was 0.25 mol/1 (molar concentration based on 1 liter of the electrolyte) unless otherwise described in the following experimental description. The experiments described below were carried out with electrolytes 1 and 2 and the reference electrolyte.

### Example 3: Preparation of Test Full Cells

The test full cells used in the experiments described below were rechargeable battery cells with two negative electrodes and one positive electrode, each of which was separated by a separator. The positive electrodes had an active material, a conductivity mediator, and a binder. The active material is named in the respective experiment. The negative electrodes contained graphite as the active material and also a binder. The test full cells were each filled with the electrolyte required for the experiments, i.e., either the reference electrolyte or electrolytes 1 or 2.

One or more, e.g., two to four identical test full cells, were prepared for each experiment. The results presented in the experiments are, where available, averages of the measured values obtained for the identical test full cells.

### Example 4: Measurement in Test Full Cells

### Top Layer Capacity:

A capacity consumed in the first cycle for the formation of a top layer on the negative electrode is an important criterion for the quality of a battery cell. This top layer is formed on the negative electrode during the first charge of the test full cell. For this top layer formation, lithium ions are irreversibly consumed (top layer capacity), so that less cycling capacity is available to the test full cell for the subsequent cycles. The top layer capacity in % of the theory consumed to form the top layer on the negative electrode is calculated according to the following formula:

Top layer capacity [in % of theory]=(Q_{lad}(x mAh)−Qₑₙₜ(y mAh))/Q_{NEL}

Q_{lad} describes the amount of charge in mAh specified in the respective experiment; Qₑₙₜ describes the amount of charge in mAh obtained when the test full cell was subsequently discharged. Q_{NEL} is the theoretical capacity of the negative electrode used. For example, the theoretical capacity is calculated to be 372 mAh/g in the case of graphite.

### Discharge Capacity:

For measurements in test full cells, for example, a discharge capacity is determined via the cycle number. For this purpose, the test full cells are charged with a certain charge current up to a certain upper potential. The corresponding upper potential is held until the charge current has dropped to a certain value. Discharge then takes place with a specific discharge rate up to a specific discharge potential. This charging method is referred to as I/U charging. This process is repeated depending on the desired number of cycles.

The upper potentials or the discharge potential and the respective charge or discharge rates are named in the experiments. The value to which the charge current must have dropped is also described in the experiments.

The term “upper potential” is used synonymously with the terms “charge potential,” “charge voltage,” “charge end voltage,” and “upper potential limit.” The terms refer to the voltage or potential to which a test full cell or battery is charged using a battery charging device.

Preferably, the battery is charged at a current rate of C/2 and at a temperature of 22° C. By definition, with a charge or discharge rate of 1 C, the nominal capacity of a test full cell is charged or discharged in one hour. A charge rate of C/2 therefore means a charge time of 2 hours.

The term “discharge potential” is used synonymously with the term “lower cell voltage.” This refers to the voltage or potential up to which a test full cell or battery is discharged using a battery charging device.

Preferably, the battery is discharged at a current rate of C/2 and at a temperature of 22° C.

The discharge capacity is obtained from the discharge current and the time until the criteria for termination of discharge are met. The accompanying figures show average values for the discharge capacities as a function of cycle number. These average values of discharge capacities are often normed to the maximum capacity reached in the particular experiment, each expressed as a percentage of the nominal capacity.

Experiment 1: Examination of the Top Layer Capacity in Test Full Cells with Either Electrolyte 1 or the Reference Electrolyte

In a first experiment, the capacity consumed in the first cycle for the formation of a top layer on the negative electrode was examined. For this purpose, test full cells according to example 3 were filled with either reference electrolyte or electrolyte 1. Electrolyte 1 contained the conducting salt Li₂B₁₂Cl₁₂ at a concentration of 0.25 mol/L. The reference electrolyte had the composition LiAlCl₄*6 SO₂. The active material of the positive electrode both when using the reference electrolyte and when using electrolyte 1 was nickel manganese cobalt oxide (NMC622).

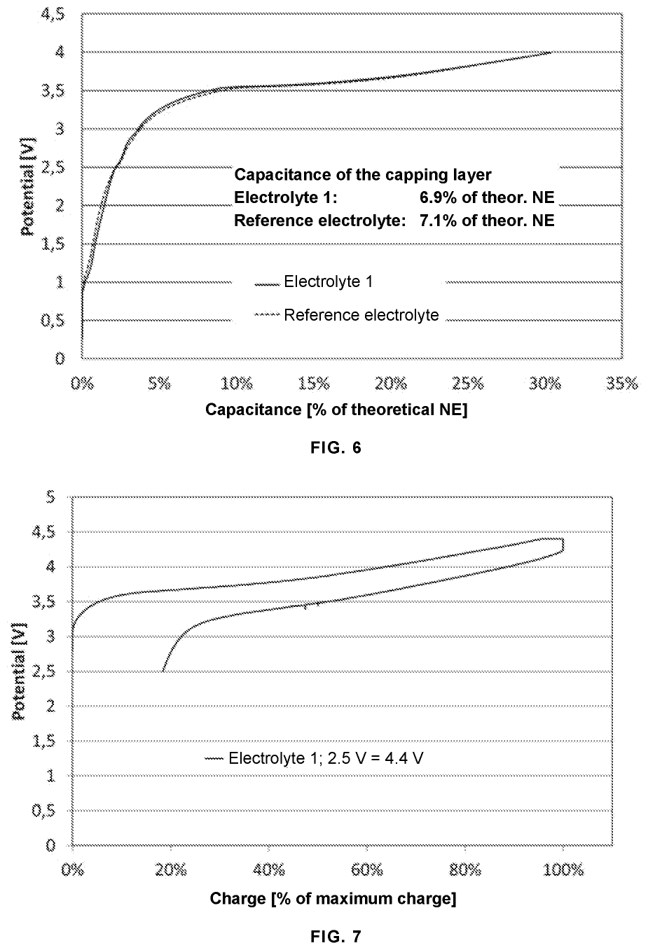

FIG. 6 shows the potential in volts [V] of the test full cells during charging as a function of capacity, which is related to the theoretical capacity of the negative electrode. Here, the dashed line shows the results for the test full cells with the reference electrolyte, and the solid line shows the results for the test full cells with electrolyte 1. First, the test full cells were charged with a current of 15 mA until a capacity of 125 mAh (Q_{lad}) was reached. Then, the test full cells were discharged with 15 mA until a potential of 2.5 volts was reached. During this process, the discharge capacity (Qₑₙₜ) was determined.

The capacity for the top layer formation is 6.9% of the theoretical capacity of the negative electrode for electrolyte 1, which is slightly lower than for the reference electrolyte, which has a value of 7.1%.

Experiment 2: Examination of the Potential Curve in Test Full Cells with Electrolyte 1 and with Nickel Manganese Cobalt Oxide as the Active Material of the Positive Electrode

FIG. 7 shows the potential curve of the first cycle in volts [V] as a function of the percentage charge, which is related to the maximum charge of the test full cell [% of max. charge]. In the first cycle of the test full cell, a top layer formation takes place on the negative electrode. For this top layer formation, lithium ions are irreversibly consumed, so that the discharge capacity of the test full cell is lower than the charge capacity. The test full cell was charged to an upper potential of 4.4 V at a charge rate of 100 mA. This was followed by discharging at a discharge rate of also 100 mA to a discharge potential of 2.5 volts.

The test full cell can be charged to a high upper potential of 4.4 volts and then discharged again. Nickel manganese cobalt oxide is a high-voltage active material and, accordingly, can be cycled well in electrolyte 1. No electrolyte decomposition, even at high potentials, is evident.

Experiment 3: Examination of the Capacity Curve in Test Full Cells with Electrolyte 1 and with Nickel Manganese Cobalt Oxide as the Active Material of the Positive Electrode

The examination of the discharge capacity curve was carried out with the test full cells from experiment 1, which were filled with either reference electrolyte or electrolyte 1.

To determine the discharge capacities (see example 4), the test full cells were charged with a current of 100 mA to an upper potential of 4.4 volts. This was followed by discharging with a current of 100 mA to a discharge potential of 2.5 volts.

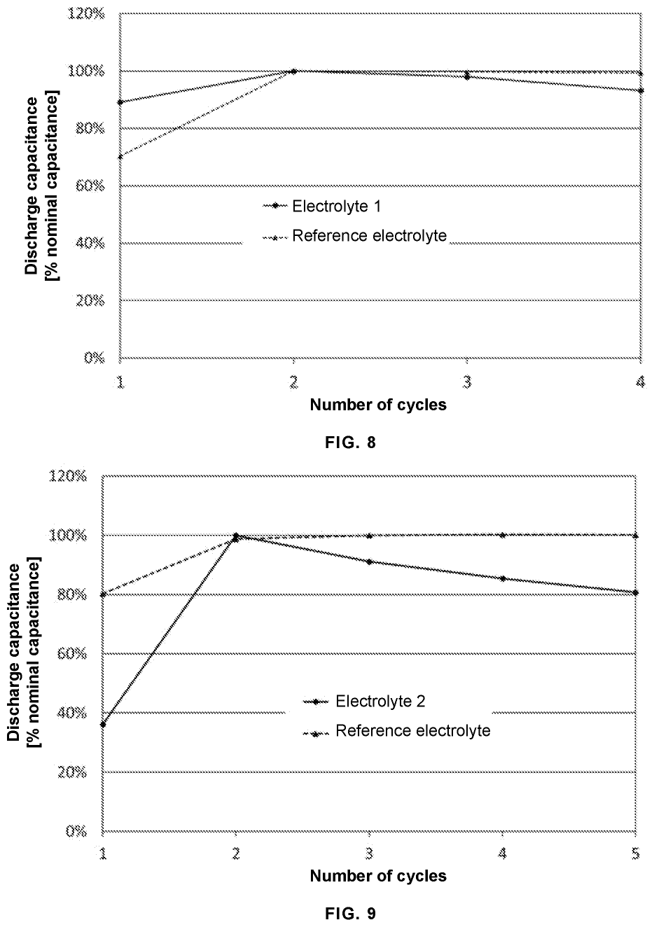

FIG. 8 shows average values for the discharge capacities normed to 100% of the maximum capacity of the two test full cells as a function of cycle number. These average values of the discharge capacities are each expressed as a percentage of the nominal capacity. The test full cells both show a stable behavior of the discharge capacities over the cycle number.

Experiment 4: Examination of the Capacity Curve in Test Full Cells with Electrolyte 2 and with Lithium Iron Phosphate as the Active Material of the Positive Electrode

To examine the discharge capacity curve, test full cells were filled with either reference electrolyte or electrolyte 2 as shown in example 3. Electrolyte 2 contained the conducting salt Li₂B₁₀Cl₁₀ at a concentration of 0.25 mol/L. The reference electrolyte used had the composition LiAlCl₄*6 SO₂. The active material of the positive electrode was lithium iron phosphate. To determine the discharge capacities (see example 4), the test full cells were charged with a current of 100 mA to an upper potential of 3.6 volts. This was followed by discharging with a current of 100 mA to a discharge potential of 2.5 volts.

FIG. 9 shows average values for the discharge capacities normed to 100% of the maximum capacity of the two test full cells as a function of cycle number. These average values of the discharge capacities are each expressed as a percentage of the nominal capacity. The test full cells both show a stable behavior of the discharge capacities over the cycle number.

### Experiment 5: Determination of Conductivities of Electrolytes 1 and 2

To determine the conductivity, electrolytes 1 and 2 were prepared with different concentrations of the compounds Li₂B₁₂Cl₁₂ or Li₂B₁₀Cl₁₀. For each concentration of the different compounds, the conductivities of the electrolytes were determined by using a conductive measurement method. In this method, a four-electrode sensor was held in contact with the solution after tempering and measured in a measuring range of 0.02-500 mS/cm.

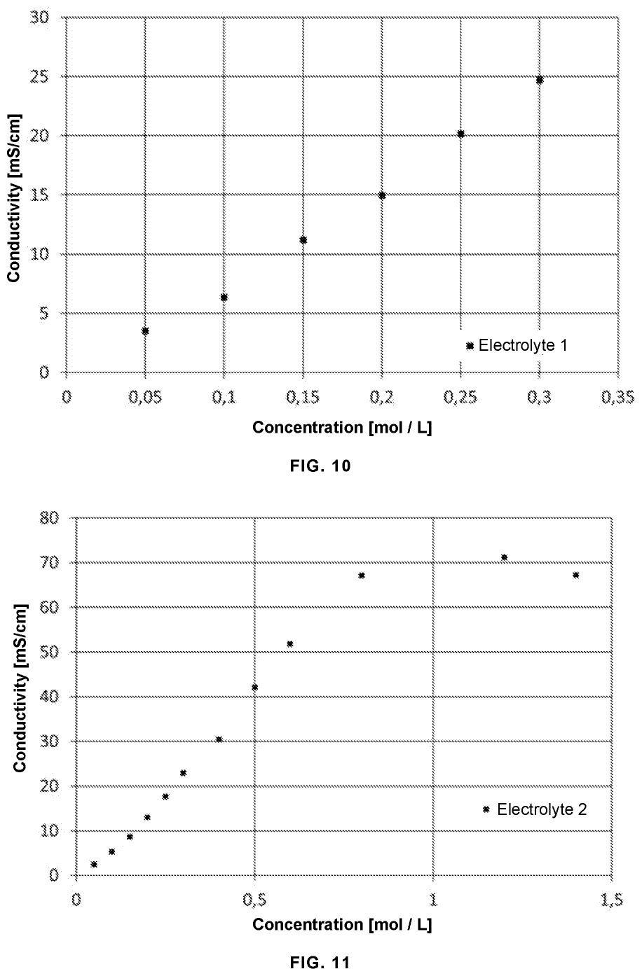

FIG. 10 shows the conductivity of electrolyte 1 as a function of the concentration of the compound Li₂B₁₂Cl₁₂. The maximum conductivity at a conducting salt concentration of 0.3 mol/L with a value of approx. 24.7 mS/cm can be seen.

FIG. 11 shows the conductivity of electrolyte 2 as a function of the concentration of the compound Li₂B₁₀Cl₁₀. A maximum conductivity can be seen at a conducting salt concentration of 1.2 mol/L with a high value of approx. 71.2 mS/cm.

In comparison, prior art organic electrolytes such as LP30 (1 M LiPF6/EC-DMC (1:1 wt.)) have a conductivity of only about 10 mS/cm.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

What is claimed is:

1. An SO₂-based electrolyte for a rechargeable battery cell, comprising at least a first conducting salt of the formula (I):
MₐBₘXₙ formula (I)
wherein
M is a metal selected from the group comprising alkali metals, alkaline earth metals, metals of group 12 of the periodic table of the elements, and aluminum;
B is the element boron;
X is a halogen; and
A, m, and n are independent integers.

2. The electrolyte according to claim 1, wherein M is lithium.

3. The electrolyte according to claim 1, wherein X is selected from the group consisting of fluorine, chlorine, bromine, and iodine.

4. The electrolyte according claim 1, wherein M is lithium, X is chlorine, and the first conducting salt has the composition selected from the group consisting of LiₐBₘClₙ, Li₂B₁₀Cl₁₀ and Li₂B₁₂Cl₁₂.

5. The electrolyte according to claim 1, wherein the electrolyte contains an amount of SO₂ selected from the group consisting of at least 1 mole of SO₂, at least 10 moles of SO₂, at least 30 moles of SO₂, and at least 50 moles of SO₂ per mole of conducting salt.

6. The electrolyte according to claim 1, comprising at least one second conducting salt which differs from the first conducting salt according to formula (I), the second conducting salt comprising an alkali metal compound selected from the group consisting of an aluminate, a halide, an oxalate, a borate, a phosphate, an arsenate, and a gallate.

7. The electrolyte according to claim 6, wherein the second conducting salt is selected from the group consisting of lithium tetrahaloaluminate and lithium tetrachloroaluminate.

8. The electrolyte according to claim 1, comprising at least one organic solvent in a concentration by weight of the electrolyte selected from the group consisting of at most 50% by weight, at most 40% by weight, at most 30% by weight, at most 20% by weight, at most 15% by weight, at most 10% by weight, at most 5% by weight, and at most 1%.

9. The electrolyte according to claim 1, comprising a composition of:
(i) 5 to 99.4% by weight of sulfur dioxide,
(ii) 0.6 to 95% by weight of the first conducting salt,
(iii) 0 to 25% by weight of the second conducting salt, and
(iv) 0 to 50% by weight of an organic solvent,
based on the total weight of the electrolyte composition.

10. A rechargeable battery cell, comprising:
an electrolyte according to claim 1;
an active metal;
at least one positive electrode;
at least one negative electrode; and
a housing.

11. The rechargeable battery cell according to claim 10, wherein the active metal is at least one metal selected from the group consisting of:
an alkali metal;
an alkaline earth metal; and
a metal of group 12 of the periodic table.

12. The rechargeable battery cell according to claim 10, wherein the negative electrode is an insertion electrode.

13. The rechargeable battery cell according to claim 12, wherein the insertion electrode contains carbon as active material.

14. The rechargeable battery cell according to claim 13, wherein the active material is modification graphite.

15. The rechargeable battery cell according to claim 10, wherein:
the positive electrode contains as active material at least one intercalation compound having the composition LiₓM′_{y}M″_{z}Oₐ;
M′ is at least one metal selected from the group consisting of the elements Ti, V, Cr, Mn, Fe, Co, Ni, Cu, and Zn;
M″ is at least one element selected from the group consisting of the elements of 2, 3, 4, 5, 6, 7, 8, 9, 10, 11, 12, 13, 14, 15, and 16 of the periodic table of the elements;
x and y are independently greater than 0;
z is greater than or equal to 0; and
a is greater than 0.

16. The rechargeable battery cell according to claim 15, wherein the intercalation compound has the composition LiₓM′_{y}M″_{z}Oₐ in which M′ is iron and M″ is phosphorus and wherein x, y, and z are equal to 1 and a is equal to 4.

17. The rechargeable battery cell according to claim 15, wherein the intercalation compound has the composition LiₓM′_{y}M″_{z}Oₐ in which M′ is manganese and M″ is cobalt and wherein x, y, and z are equal to 1 and a is equal to 4.

18. The rechargeable battery cell according to claim 15, wherein the intercalation compound has the composition LiₓM′_{y}M″_{z}Oₐ, wherein M′ comprises nickel and manganese and M″ is cobalt.

19. The rechargeable battery cell according to claim 10, wherein the positive electrode comprises at least one metal compound selected from the group consisting of a metal oxide, a metal halide, and a metal phosphate.

20. The rechargeable battery cell according to claim 19, wherein the metal of the metal compound is a transition metal of atomic numbers 22 to 28 of the periodic table.

21. The rechargeable battery cell according to claim 10, wherein the positive electrode and/or the negative electrode comprise a conducting element which is planar in the form of a metal sheet or foil, or three-dimensional in the form of a porous metal structure.

22. The rechargeable battery cell according to claim 21, wherein the conducting element is a metal foam.

23. The rechargeable battery cell according to claim 10, wherein the positive electrode and/or the negative electrode comprises at least one binder selected from the group consisting of:
a fluorinated binder, a polyvinylidene fluoride, a terpolymer of tetrafluoroethylene, hexafluoropropylene, and vinylidene fluoride,
a polymer composed of monomeric structural units of a conjugated carboxylic acid or of the alkali metal salt, alkaline earth metal salt, an ammonium salt of this conjugated carboxylic acid or of a combination thereof,
a binder consisting of a polymer based on monomeric styrene and butadiene structural units, and
a binder selected from the group of consisting of carboxymethyl celluloses,
wherein the binder is present in a concentration selected from the group consisting of at most 20% by weight, at most 15% by weight, at most 10% by weight, at most 7% by weight, at most 5% by weight, and at most 2% by weight based on the total weight of the positive electrode or the negative electrode.

24. The rechargeable battery cell according to claim 10, comprising a plurality of positive electrodes and a plurality of negative electrodes arranged alternately stacked in the housing.

25. The rechargeable battery cell according to claim 24, wherein the positive electrodes and the negative electrodes are each electrically separated from each other by at least one separator.

26. The electrolyte according to claim 1, wherein X is fluorine or chlorine.
